(19) United States
(12) Patent Application Publication
(10) Pub. No.: US 2017/0000084 A1
(43) Pub. Date: Jan. 5, 2017

(54) METHOD AND APPARATUS FOR SUBSTANTIALLY CLEANING A DOG PAW OR THE LIKE.

(71) Applicant: Ken Lamont Joyner, Pasadena, CA (US)

(72) Inventor: Ken Lamont Joyner, Pasadena, CA (US)

(21) Appl. No.: 14/791,394

(22) Filed: Jul. 3, 2015

(51) Int. Cl. A01K 13/00

(52) U.S. Cl. CPC A01K 13/001

(57) ABSTRACT

A manual apparatus (2) for cleaning dog's paws (18) includes a soft, flexible and porous elongated tapered tube having a closed end 6 that slips snuggly over a dog's paw (18) for rotating to substantially scrape and remove debris (20) and absorb fluid. A utilization method is also included.

### FIELD OF THE INVENTION

This invention relates to devices for manually cleaning dog paws—particularly cleaning the dirt, debris or mud which often occurs when walking dogs.

### BACKGROUND OF THE INVENTION

It is very common for dog owners (consumers) to walk their dogs on a regular basis for exercise, leisure or relieving bodily functions. It is also a known problem that dogs frequently get their paws dirty during these walks with foreign substances like; dirt, debris, water or mud which usually results in them tracking these substances onto interior surfaces such as; carpets, rugs and floors or the like.

Consumers normally rely on simple rags/towels as the method to clean the paws before the dog is allowed to walk on the interior surfaces. There are also products such as specialty carpets and paw cleaners on the market that are intended to remove, brush, rinse, wipe, wash or otherwise agitate paws to eliminate the tracking.

The products on the market which I have come across are: “The Paw Plunger”, “The Paw Wash”, “The Spotless Paw Cleaning Glove” and “ Soggy Doggy Doormat”.

While the above products and methods are helpful to pet owners, they tend to be very labor intensive, inconvenient, complex, non-efficient and sometimes uncomfortable for the dog which causes owners to struggle with positioning dog for paw cleaning. Most tend to be relatively expensive too.

Consequently, an apparatus and method which is simple, convenient, efficient, inexpensive and more comfortable for dogs to make positioning them easier would be very beneficial for dog owners.

### SUMMARY OF THE INVENTION

The invention comprises a simple, compact, efficient, inexpensive and convenient manual method and apparatus to significantly minimize or eliminate dogs from tracking dirt or debris onto interior surfaces. Achieved in a way which can be dry and requires no hardware, tools or extensive labor, but has the added option of using soap and/or water if further sanitized cleaning is desired.

### DRAWINGS—FIGURES

FIG. 1 shows an elevational rear view of the apparatus.

FIG. 2 shows an elevational front view of the apparatus.

FIG. 3 shows an elevational side view of the apparatus.

FIG. 4 shows an isometric cross-sectional view of the apparatus along the A-A line of FIG. 2.

FIG. 5 shows an isometric view of the apparatus.

DRAWINGS - Reference Numerals

```
  2. Apparatus
  4. Open tube end
  6. Closed tube end
  8. Exterior grooves
10. Interior grooves
12. Imprint able surface
14. Branding print
16. Instructional print
18. Dog paw
20. Dirt/debris
22. Human hand
```

### DETAILED DESCRIPTION

Apparatus

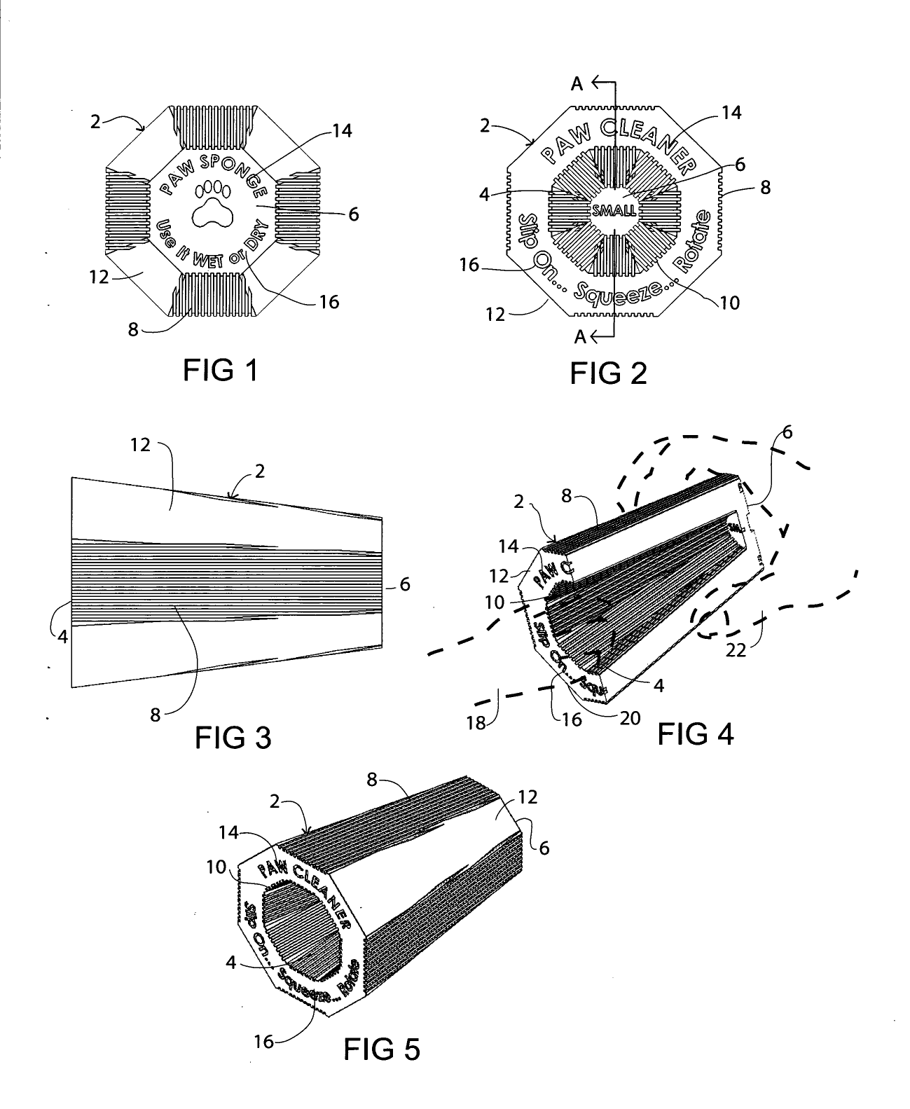

The invention apparatus is graphically illustrated in FIG. 1 through FIG. 5.

The apparatus 2 forms a tube with a closed end 6. It is preferred that the tube is of an octagonal shape (8 equal sides). The tube narrows to form the closed end 6. The open end 4 of the tube is of a predefined inside diameter so as to enable the paw 18 of a dog to be slipped through and into the tube. The closed end 6 is of a predefined inside diameter to enable the tube to narrow to the extent that the paw 18 of the dog will fit snugger the further it freely slides into the tube.

The outside diameter of both ends 4&6 is of a predefined dimension to enable a human hand 22 to comfortably and effectively grip the apparatus 2 when using.

The interior surfaces of the tube forms a plurality of interior grooves 10 recessed a predefined depth from the interior surface to enable variable friction to occur when the dog's paw 18 makes contact. The result enables dirt, debris 20 or the like to be substantially dislodged from the paw 18 enabling it to be substantially cleaned.

Similar exterior grooves 8 are recessed strategically on the outer surface of the tube to enable a better gripping surface for holding the apparatus 2 when using as intended.

The length and thickness of the tube is of a predefined dimension to enable the apparatus 2 to work effectively. It is preferred (but not absolutely required) that separate sizes are provided to accommodate the various sizes of dogs paws 18 (e.g. small, medium and large).

For example (not absolutely required), an outside diameter of approximately 2.125″ with an approximate 0.43″ perimeter wall thickness and an overall approximate length of 3″ with a narrowing angle of approximately 7.7 degrees proves to work well for the “small” size. The “small” size can be scaled UP to 1.275% to make the “medium” size (for example). The “medium” size can likewise be scaled up to 1.275% to make the “large” size (for example).

It is preferred (for example) that branding and/or instructional print (text/graphics) 14&16 be recessed on the radial surface of the open end 4 and the outside surface of the closed end 6, as well as the size printed on the interior closed surface. This is meant to at least minimize (if not eliminate) the need for relevant packaging of the product (apparatus) 2.

It is also preferred that the apparatus 2 is a singly formed part which is injection molded or the like. Reaction injection molding (RIM) is also believed to be a viable option.

It is further preferred that the tube is made of a soft and flexible spongy material that does not repel (or substantially repel) liquid like water. This will enable common wet substances that often are on dogs paws when they are walked (like water) to be substantially removed and avoid tracking onto inside surfaces (carpets, floors, furniture etc . . . ). An open-cell urethane foam has proven to be effective.

Method

The method result is graphically indicated with FIG. 4.

The apparatus 2 as described above is slipped over the dog's paw 18 through the open 4 end and towards the closed end 6. It is preferred that the apparatus then be squeezed while being rotated around the paw 18 in order to more effectively substantially remove the dirt/debris 20.

The above steps can be repeated if/as needed to achieve the desired results, then simply removed by sliding the apparatus 2 away from the paw 18 until completely removed.

The apparatus 2 can be pre wetted with a desired amount of water or other desired fluid(s) for more effective cleaning and/or deodorizing of the paw 18 (e.g. soap or other cleaning substance or the like).

Since the preferred material of the apparatus 2 is a soft & flexible spongy material, the apparatus can be effectively cleaned and rinsed off easily if desired.

While the above description contains much specificity, they should not be construed as limitations on the scope of the invention, but rather as exemplifications of a basic apparatus and method thereof. Many other possible variations are obvious to individuals skilled in the art.

For Example:

The specific apparatus design and material described can be altered and yet achieve the desired results as described.

The apparatus can be separately formed or combined.

The interior “grooves” can be modified to be more effective or even eliminated.

The apparatus dimensions and design can be modified to be fit multiple size dog paws

The tube shape can be designed to any random or structured shape, yet achieve the same desired result.

The back end can be completely or partially closed.

The end(s) can have a formed or separately formed grip or the like.

The exterior surface material can be rougher for a better grip. The material can at least be substantially anti-bacterial or ant-microbial or the like.

A clip or hanger can be formed or separately attached to enable product to conveniently hang from door, owner, pet or other.

The interior design can be altered to act as a massager, soother or the like for the dog's paw.

The apparatus can be designed to collapse for more efficient shipping, packaging and display space (for example).

The “tube” design can be more of a shallower “cup” design (covering less of the leg or only the paw or portion thereof.)

The instructions or steps described can be performed to varying degree and/or in varying, order sequence or combination to achieve the desired end results described.

Thus the scope of the invention should be determined by the appended claims and their legal equivalents, rather than by the methods described and illustrated.

I claim:

1. An apparatus for substantially cleaning a dog paw or the like comprises:
a) at least one substantially elongated tube or the like made of at least one substantially soft and flexible material; of at least one predefined size to enable it to be securely gripped at least with at least one human hand,
b) at least one substantially hollow core thereby enabling at least one paw of at least one dog to be at least substantially slipped therein to be at least substantially cleaned by making substantial contact with at least one interior surface of said hollow core.

2. The apparatus of claim 1; wherein said material is at least one foam or rubber.

3. The apparatus of claim 1; wherein said material is at least one substantially water absorbent spongy foam or rubber, thereby enabling at least one liquid on said paw to be substantially absorbed when said contact is made.

4. The apparatus of claim 1; wherein said material enables dirt or debris or the like to be substantially scrapped off or removed from the resulting friction of said substantial contact.

5. The apparatus of claim 1; wherein said hollow core is substantially tapered, thereby enabling said paw to fit increasingly snug as said paw goes deeper into said tube.

6. The apparatus of claim 1; wherein the shape of said tube is at least one circle.

7. The apparatus of claim 1; wherein the shape of said tube is at least one polygon.

8. The apparatus of claim 1; further comprising a means to substantially scrape and deposit debris.

9. The apparatus of claim 8; wherein said means to substantially scrape and deposit said debris is at least one formed recessed groove on interior core surface thereby enabling debris to be substantially scrapped and deposited.

10. The apparatus of claim 1; wherein one end of said tube is closed.

11. The apparatus of claim 1; wherein said predefined size enables it to be securely rotated at least with at least one human hand

12. The apparatus of claim 1; which further comprises strategically embedding at least one substantial branding or instructional for use image thereby at least substantially minimizing the need for including relevant packaging or the like to communicate said instruction to consumer.

13. A method for manually cleaning a dog paw or the like utilization of an apparatus which comprises:
a) at least one substantially elongated tube or the like made of at least one substantially soft and flexible material; of at least one predefined size to enable it to be securely gripped at least with at least one human hand,
b) at least one at least substantially hollow core thereby enabling at least one paw of at least one dog to be at least substantially slip therein to be at least substantially cleaned by making substantial contact with at least one interior surface of said hollow core.

14. The method of claim 13 further including; substantially placing or slipping said dogs paw through the hollow core of said apparatus.

15. The method of claim 13 further including; substantially squeezing said apparatus around said paw when slipped therein, thereby enabling said paw to be said cleaned.

16. The method of claim 13 further including; substantially rotating said apparatus around said paw when slipped therein, thereby enabling said paw to be said cleaned.

17. The method of claim 13 further including; removing said apparatus from said dog paw.

18. The method of claim 13 further including; repeating said method as needed to clean dogs paw as desired.

19. The method of claim 13 further including; wetting said apparatus with fluid as desired.

20. The method of claim 13 further including; putting at least one paw cleaning solution or the like onto apparatus as desired.
